(19) United States
(12) Patent Application Publication
(10) Pub. No.: US 2023/0033543 A1
(43) Pub. Date: Feb. 2, 2023

(54) PLANT BASED MEAT ANALOGUE PREPARED BY WET EXTRUSION OF MIXTURE OF PLANT PROTEIN ISOLATES AND GLUTEN

(71) Applicant: SOCIETE DES PRODUITS NESTLE S.A., Vevey (CH)

(72) Inventors: CINDY PELLOUX, Ithaca, NY (US); PATRICK PIBAROT, Territet (CH); CHRISTOPHE JOSEPH ETIENNE SCHMITT, Servion (CH)

(21) Appl. No.: 17/758,146

(22) PCT Filed: Dec. 31, 2020
(86) PCT No.: PCT/EP2020/088078

§ 371 Date: Jun. 29, 2022

(30) Foreign Application Priority Data
Dec. 31, 2019 (EP) 19220236.4

(51) Int. Cl. A23J 3/22; A23J 3/16; A23J 3/18; A23J 3/26

(52) U.S. Cl. CPC A23J 3/227; A23J 3/16; A23J 3/18; A23J 3/26

(57) ABSTRACT

The present invention relates to a method of making a cold cut meat analogue, said method comprising: mixing a combination of two or more plant protein isolates, wheat gluten and optionally other ingredients, wherein the % (w/w) dry weight ratio of the combination of two or more plant protein isolates to wheat gluten ranges from 65:35 to 85:15, and wherein at least one plant protein isolate is derived from pea and/or at least one plant protein isolate is derived from soy; adding water and mixing to form a dough; extruding the dough by wet extrusion; cooling; and optionally cutting. A cold cut meat analogue made by the method of the invention is also provided.

Recent years have seen a substantial increase in consumer demand for vegetarian and vegan products. Plant protein-based cold cuts currently on the market are mainly produced by mixing rehydrated texturized vegetable protein (TVP) with a binder, oil and various coloring and flavoring ingredients to form a dough. Some products have brown inclusions or have a mortadella-like texture, whilst others may have a pâté like color and texture.

Typically, the dough is cooked using large sausage technology to provide cohesiveness and texture. The final product can be sliced and packaged as cold cut slices. However, these products miss the desired fibrous and “bitey” texture which is typical of cold cut meats.

There is a clear need to create vegetarian and vegan cold cut products which have an improved texture, mouthfeel, flavor and taste compared to that of existing cold cut products found on the market.

### SUMMARY OF THE INVENTION

The present invention relates to a method of making a cold cut meat analogue, said method comprising:

a. Mixing a combination of two or more plant protein isolates, wheat gluten and optionally other ingredients, wherein the % (w/w) dry weight ratio of the combination of two or more plant protein isolates to wheat gluten ranges from 65:35 to 85:15, and wherein at least one plant protein isolate is derived from pea and/or at least one plant protein isolate is derived from soy;

b. Adding water and mixing to form a dough;

c. Extruding the dough by wet extrusion;

d. Cooling; and

e. Optionally cutting.

It has surprisingly been found that by varying the ratio of plant protein isolate and wheat gluten, different structures and textures can be obtained. A plant protein isolate: wheat gluten ratio from 65:35 to 85:15 provides a structure and texture approaching that of ham cold cut.

Further addition of starch and/or maltodextrin allows fine tuning of the continuity or discontinuity of the extruded slabs. Fibrous texture is reduced but the slab exits more continuously across the whole width of the die slit. The absence of starch and/or maltodextrin results in an extrudate with a more fibrous texture.

### DESCRIPTION OF THE INVENTION

Method of Making a Cold Cut Meat Analogue

The present invention relates to a method of making a meat analogue, said method comprising: mixing a combination of two or more plant protein isolates and wheat gluten; adding liquid and mixing to form a dough; extruding the dough; and cooling.

In particular, the present invention relates to a method of making a cold cut meat analogue, said method comprising:

a. Mixing a combination of two or more plant protein isolates and wheat gluten, wherein the % (w/w) dry weight ratio of the combination of two or more plant protein isolates to wheat gluten ranges from 65:35 to 85:15, and wherein at least one plant protein isolate is derived from pea and/or at least one plant protein isolate is derived from soy;

b. Adding water and mixing to form a dough;

c. Extruding the dough by wet extrusion;

d. Cooling; and

e. Optionally cutting.

In one embodiment, the combination of two or more plant protein isolates are present in the dough at a final concentration of between 5 to 45% (w/w).

In one embodiment, a combination of two or more plant protein isolates are present in the dough at a final concentration of between 20 to 40% (w/w).

In one embodiment, one of the plant protein isolates is present in the dough at a final concentration of between 10 to 20% (w/w).

In one embodiment, two or more of the plant protein isolates are derived from pea, for example yellow pea.

In one embodiment, at least one of the plant protein isolates is derived from pea, for example yellow pea, and at least one of the plant protein isolates is derived from soy.

In one embodiment, one of the pea protein isolates is Nutralys S85F. Preferably, Nutalys S85F is present in the dough at a final concentration of between 40 to 60% of the total pea protein isolate concentration, for example at about 50%. In one embodiment, one of the pea protein isolates is Pisane B9. Preferably, Pisane B9 is present in the dough at a final concentration of between 40 to 60% of the total pea protein isolate concentration, for example at about 50%.

In one embodiment, no pea protein isolate is present in a concentration greater than 60% of the total pea protein isolate concentration.

In one embodiment, two or more of the plant protein isolates are derived from soy.

In one embodiment, pea protein isolate and wheat gluten are present in the dough in a % (w/w) dry weight ratio of about 70:30.

In one embodiment, Pisane B9, Nutralys S85F and wheat gluten are present in the dough in a % (w/w) dry weight ratio of about 35:35:30.

In one embodiment, wheat gluten is present in the dough at a final concentration of between 5 to 20% (w/w).

In one embodiment, step a) further comprises mixing starch, wherein said starch is present in the dough at a final concentration of between 1 to 6% (w/w), for example about 2%.

In one embodiment, the starch is wheat starch.

In one embodiment, step a) further comprises mixing maltodextrin.

In one embodiment, step a) further comprises mixing lecithin, preferably sunflower lecithin, for example sunflower lecithin E322.

In one embodiment, step a) further comprises mixing starch, maltodextrin and lecithin, wherein starch is present in the dough at a final concentration of between 1 to 6% (w/w), for example about 2%.

In one embodiment, the starch, maltodextrin, and lecithin are added as ingredients of a white colorant.

In one embodiment, step a) further comprises mixing base note meat flavor.

In one embodiment, ferric sulfate is mixed. This serves to fortify the meat analogue with a source of iron. The addition of ferric sulfate has no significant impact on the color of the meat analogue.

In one embodiment, the dough is extruded using a twin screw extruder. In one embodiment, the dough is heated, for example in order to reach a state at which the protein melted and texturized in a fibrous organization.

In one embodiment, the meat analogue is a ham analogue.

In one embodiment, the meat analogue does not comprise animal derived ingredients, for example egg.

### Cut Meat Analogue

The present invention also relates to a meat analogue made by a method as described herein.

The present invention also relates to a cold cut meat analogue, wherein said cold cut meat analogue comprises a combination of two or more plant protein isolates and wheat gluten, wherein the % (w/w) dry weight ratio of plant protein isolates to wheat gluten ranges from 65:35 to 85:15, wherein at least one of the plant protein isolates is derived from pea and/or at least one of the plant protein isolates is derived from soy.

In one embodiment, the meat analogue comprises a combination of two or more plant protein isolates at a final concentration of between 5 to 45% (w/w).

In one embodiment, the meat analogue comprises a combination of two or more plant protein isolates at a final concentration of between 20 to 40% (w/w).

In one embodiment, one of the plant protein isolates is present at a final concentration of between 10 to 20% (w/w).

In one embodiment, two or more of the plant protein isolates are derived from pea, for example yellow pea.

In one embodiment, at least one of the plant protein isolates is derived from pea, for example yellow pea, and at least one of the plant protein isolates is derived from soy.

In one embodiment, the two or more plant protein isolates derived from pea have not been extracted using an organic solvent.

In one embodiment, the two or more plant protein isolates derived from pea have a protein content between 85 to 90 wt %.

In one embodiment, one of the pea protein isolates is Nutralys S85F. Preferably, Nutalys S85F is present in the dough at a final concentration of between 40 to 60% of the total pea protein isolate concentration, for example at about 50%.

In one embodiment, one of the pea protein isolates is Pisane B9. Preferably, Pisane B9 is present in the dough at a final concentration of between 40 to 60% of the total pea protein isolate concentration, for example at about 50%.

In one embodiment, no pea protein isolate is present in a concentration greater than 60% of the total pea protein isolate concentration.

In one embodiment, two or more of the plant protein isolates are derived from soy.

In one embodiment, pea protein isolate and wheat gluten are present in the meat analogue in a % (w/w) dry weight ratio of about 70:30.

In one embodiment, Pisane B9, Nutralys S85F and wheat gluten are present in the meat analogue in a % (w/w) dry weight ratio of about 35:35:30.

In one embodiment, the meat analogue comprises wheat gluten at a final concentration of between 5 to 20% (w/w).

In one embodiment, the meat analogue further comprises starch, and wherein said starch is present at a final concentration of between 1 to 6% (w/w), for example about 2%.

In one embodiment, the starch is wheat starch.

In one embodiment, the meat analogue further comprises maltodextrin.

In one embodiment, the meat analogue further comprises maltodextrin and lecithin, preferably sunflower lecithin.

In one embodiment, the meat analogue further comprises starch, maltodextrin and lecithin, wherein starch is present at a final concentration of between 1 to 6% (w/w), for example about 2%.

In one embodiment, the starch, maltodextrin, and lecithin are added as ingredients of a white colorant.

In one embodiment, the meat analogue further comprises a base note meat flavor.

In one embodiment, the meat analogue further comprises a top note ham flavor and/or a color ingredient.

In some embodiments, the meat analogue further comprises ferric sulfate.

In one embodiment, the meat analogue is a ham analogue.

In one embodiment, the meat analogue does not comprise animal derived ingredients, for example egg.

### Use of Ingredients to Make a Cold Cut Meat Analogue

The present invention also relates to the use of a combination of two or more plant protein isolates and wheat gluten to make a cold cut meat analogue, wherein the % (w/w) dry weight ratio of plant protein isolates to wheat gluten ranges from 65:35 to 85:15, wherein at least one of the plant protein isolates is derived from pea and/or at least one of the plant protein isolates is derived from soy.

In one embodiment, the combination of two or more plant protein isolates are present at a final concentration of between 5 to 45% (w/w).

In one embodiment, a combination of two or more plant protein isolates are present at a final concentration of between 20 to 40% (w/w).

In one embodiment, one of the plant protein isolates is present at a final concentration of between 10 to 20% (w/w).

In one embodiment, two or more of the plant protein isolates are derived from pea, for example yellow pea.

In one embodiment, at least one of the plant protein isolates is derived from pea, for example yellow pea, and at least one plant protein isolate is derived from soy.

In one embodiment, one of the pea protein isolates is Nutralys S85F. Preferably, Nutalys S85F is present in the dough at a final concentration of between 40 to 60% of the total pea protein isolate concentration, for example at about 50%. In one embodiment, one of the pea protein isolates is Pisane B9. Preferably, Pisane B9 is present in the dough at a final concentration of between 40 to 60% of the total pea protein isolate concentration, for example at about 50%.

In one embodiment, no pea protein isolate is present in a concentration greater than 60% of the total pea protein isolate concentration.

In one embodiment, two or more of the plant protein isolates are derived from soy.

In one embodiment, pea protein isolate and wheat gluten are present in a % (w/w) dry weight ratio of about 70:30.

In one embodiment, Pisane B9, Nutralys S85F and wheat gluten are present in a % (w/w) dry weight ratio of about 35:35:30.

In one embodiment, wheat gluten is present at a final concentration of between 5 to 20% (w/w).

In one embodiment, starch is present in the cold cut meat analogue, wherein said starch is present at a final concentration of between 1 to 6% (w/w), for example about 2%.

In one embodiment, the starch is wheat starch.

In one embodiment, starch, maltodextrin and lecithin are present in the cold cut meat analogue, wherein starch is present at a final concentration of between 1 to 6% (w/w), for example about 2%.

In one embodiment, the starch, maltodextrin, and lecithin are added as ingredients of a white colorant.

In one embodiment, a base note meat flavor is present in the cold cut meat analogue.

In one embodiment, a top note ham flavor and/or color ingredient is present in the cold cut meat analogue.

In one embodiment, ferric sulfate is present in the cold cut meat analogue.

In one embodiment, the cold cut meat analogue is a ham analogue.

In one embodiment, the cold cut meat analogue does not comprise animal derived ingredients.

### Definitions

As used herein, “about,” “approximately” and “substantially” are understood to refer to numbers in a range of numerals, for example the range of −20% to +20% of the referenced number, preferably −10% to +10% of the referenced number, preferably −5% to +5% of the referenced number, more preferably −1% to +1% of the referenced number, most preferably −0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

The products disclosed herein may lack any element that is not specifically disclosed herein. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified. Any embodiment disclosed herein can be combined with any other embodiment disclosed herein unless explicitly and directly stated otherwise.

The term plant protein isolate, as used herein is a plant material having a protein content of at least about 80% plant protein on a dry basis, preferably between 80-96%, or between 84-92%, or between 85-90% plant protein on a dry basis.

Unless defined otherwise, all technical and scientific terms and any acronyms used herein have the same meanings as commonly understood by one of ordinary skill in the art in the field of the invention. Although any compositions, methods, articles of manufacture, or other means or materials similar or equivalent to those described herein can be used in the practice of the present invention, the preferred compositions, methods, articles of manufacture, or other means or materials are described herein.

A “meat-analogue” or “cold cut meat analogue” is also called a meat alternative, meat substitute, mock meat, faux meat, imitation meat, or (where applicable) vegetarian meat or vegan meat. Meat analogue is understood to mean a food made from non-meats, without other animal products, such as dairy. Therefore protein from an animal source is completely absent. Protein from an animal source can be animal meat protein and/or milk protein. A meat-analogue food product is a composition in which meat (i.e. skeletal tissue and non-skeletal muscle from mammals, fish and form) and meat by-products (i.e. the non-rendered clean parts, other than meat, derived from slaughtered mammals, form or fish) are completely absent. The market for meat imitations includes vegetarians, vegans, non-vegetarians seeking to reduce their meat consumption for health or ethical reasons, and people following religious dietary laws. Cold cut meats are also known as lunch meats, luncheon meats, cooked meats, sliced meats, cold meats, and deli meats. Typically, cold cuts are precooked and served cold. Typical examples are ham, pork, or meatloaf.

### Pea Protein Isolate

One of the plant protein isolates may be pea protein isolate Nutralys S85F or a pea protein isolate having the functional properties of Nutralys S85F. One of the plant protein isolates may be pea protein isolate Pisane B9 or a pea protein isolate having the functional properties of Pisane B9. Each pea protein isolate may be present in the dough or meat analogue at a final concentration of between 13 to 16% (w/w).

Other Ingredients

Aside from the plant protein isolates and wheat gluten, the dough may comprise the following other ingredients: coconut oil, rapeseed oil, sodium chloride iron complex, color red beet, White Avalanche, and water. White Avalanche is comprised of starch, maltodextrin and sunflower lecithin E322.

### EXAMPLES

### Example 1

General Methodology

In classical extrusion, the extruder is fed with a powder blend and a liquid injection. However, it was found that this limited the time to completely hydrate the protein isolate powders. The dough was therefore prepared next to the extruder by mixing the powder blend and the liquid. The dough obtained was then pumped in the extruder, thereby allowing the optimization of the protein hydration and also minimized protein hydration variations.

The protein powders and starch were mixed with a Prodima ACMJ 50 powder mixer. The flavor blend was dispersed in around one liter of water to help the dissolution. The vitamin premix was also dispersed in around 200 ml of water using a stirring plate. These ingredients were added to the dough, which was transferred in a VEMAG Robot 500 to be pumped into the extruder.

In order to keep a stable color and top notes, these were injected at the end of the extrusion process. The residence time in the extruder was therefore short and it avoided the degradation of components.

The process employed a twin screw extruder to transport and heat the dough to the appropriate temperature. The arm was to reach a state at which the protein melted and texturized in a fibrous organization.

### Example 2

### Recipe Development

The initial recipe was manufactured with a twin screw extruder and a coat hanger die. The color was adjusted by using food colorant bought in a local supermarket. The protein composition that was used resulted in slices that looked like ham and, although the flavor and taste were not developed, the texture and “biteyness” were quite satisfactory.

The objective was therefore to develop a recipe which had an optimized flavor, taste and nutritional balance. The first recipes were developed using a blend of pea protein isolate (Nutralys S85F) from Roquette and wheat gluten Roquette (Lestrem). The dough was prepared in a dough mixer and pumped into the extruder. A combination of base note and top note flavors for meat and ham notes were also added.

Several recipe modifications were tested. Pea protein isolate Nutralys was replaced by Pisane B9 from Cosucra. However, 100% Pisane B9 resulted in an over texturized slab and difficulties to extrude through the die.

It was decided to adjust the fibrous texture by using a mixture of pea Pisane B9 from Cosucra and Pea Roquette Nutralys. Pea Nutralys was found to produce a less fibrous texture than pea Cosucra B9.

The following recipe was developed as shown in Table 1:

TABLE 1

| Ingredients | g/100 g | |
|---|---|---|
| Protein pea Nutralys S85F Roquette | 15.8 | % |
| Pisane B9 | 15.8 | % |
| Vital Wheat Gluten | 13.6 | % |
| Coconut oil | 0.1 | % |
| Rapeseed oil | 0.1 | % |
| Water | 52.2 | % |
| Salt NaCI Iodised | 0.54 | % |
| Fe Complex | 0.001075 | % |
| Color red beet | 0.03 | % |

| | |
|---|---|
| Total | 100 |

The extrudate was highly fibrous but, because of this fibrous texture, the flow in the die was disturbed and it was difficult to extrude a continuous slab.

The addition of White Avalanche white coloring to the dough recipe was tested. The recipe used is shown in Table 2. This coloring is mainly composed of starch and maltodextrin. The improved dough flow in the die allowed to obtain continuous regular slabs.

TABLE 2

| Ingredients | g/100 g |
|---|---|
| Protein pea Nutralys S85F Roquette | 13.9 |
| Pisane B9 | 13.9 |
| Vital Wheat Gluten | 11.9 |
| Coconut oil | 0.3 |
| Rapeseed oil | 0.3 |
| Water | 52.0 |
| Salt NaCI Iodised | 0.47 |
| Fe Complex | 0.001054 |
| White Avalanche | 5.55 |
| Color red beet | 0.03 |
| Total | 100 |

The effect of adding micro ground Texturized Vegetable Protein (TVP) to improve texture and water holding capacity of the extruded slab was tested. The texture and appearance was not significantly changed by TVP addition.

However, the surface texture of the slab appeared to be less smooth with fibrous relief at the surface. This is not desirable for vegetarian ham slices.

The replacement of White Avalanche by 2% wheat starch was tested. The texture of the slab was not significantly modified, although the surface of the slab appeared to be smoother with White Avalanche. White Avalanche is a mixture of starch and maltodextrin with sunflower lecithin E322. The presence of small amount of lecithin may have improved the surface roughness.

1. A method of making a cold cut meat analogue comprising:
a. Mixing a combination of two or more plant protein isolates and wheat gluten, wherein the % (w/w) dry weight ratio of the combination of two or more plant protein isolates to wheat gluten ranges from 65:35 to 85:15, and wherein at least one plant protein isolate is derived from pea and/or at least one plant protein isolate is derived from soy;
b. Adding water and mixing to form a dough;
c. Extruding the dough by wet extrusion; and
d. Cooling.

2. The method according to claim 1, wherein the combination of two or more plant protein isolates are present in the dough at a final concentration of between 5 to 45% (w/w).

3. The method according to claim 1, wherein the combination of two or more plant protein isolates are present in the dough at a final concentration of between 20 to 40% (w/w).

4. The method according to claim 1, wherein one of the plant protein isolates is present in the dough at a final concentration of between 10 to 20% (w/w).

5. The method according to claim 1, wherein two or more of the plant protein isolates are derived from yellow pea.

6. The method according to claim 1, wherein at least one of the plant protein isolates is derived from yellow pea and at least one of the plant protein isolate is derived from soy.

7. The method according to claim 1, wherein two or more of the plant protein isolates are derived from soy.

8. The method according to claim 1, wherein wheat gluten is present in the dough at a final concentration of between 5 to 20% (w/w).

9. The method according to claim 1, wherein step a) further comprises mixing starch, for example wheat starch, and wherein said starch is present in the dough at a final concentration of between 1 to 6% (w/w), for example about 2%.

10. The method according to claim 9, wherein step a) further comprises mixing maltodextrin and lecithin.

11. The method according to claim 10, wherein the starch, maltodextrin, and lecithin are added as ingredients of a white colorant.

12. The method according to claim 1, wherein a top note ham flavor and/or color ingredient is added during the wet extrusion process.

13. A cold cut meat analogue made by a method according to claim 1.

14. A cold cut meat analogue, wherein said cold cut meat analogue comprises a combination of two or more plant protein isolates and wheat gluten, wherein the % (w/w) dry weight ratio of plant protein isolates to wheat gluten ranges from 65:35 to 85:15, wherein at least one of the plant protein isolates is derived from pea and/or at least one of the plant protein isolates is derived from soy.

15. (canceled)
